(19) United States
(12) Patent Application Publication
(10) Pub. No.: US 2012/0092231 A1
(43) Pub. Date: Apr. 19, 2012

(54) ELECTRONIC DEVICE WITH MULTIPLE ANTENNAS AND ANTENNA OPERATION METHOD THEREOF

(75) Inventors: CHIEN-CHANG LIU, Tu-Cheng (TW); CHUNG-YU HUNG, Tu-Cheng (TW); KUN-LIN SUNG, Tu-Cheng (TW)

(73) Assignee: CHI MEI COMMUNICATION SYSTEMS, INC., Tu-Cheng City (TW)

(21) Appl. No.: 12/960,627

(22) Filed: Dec. 6, 2010

(30) Foreign Application Priority Data
Oct. 18, 2010 (TW) 99135461

(51) Int. Cl. H01Q 1/00

(52) U.S. Cl. 343/904

(57) ABSTRACT

An electronic device with multiple antennas includes a first antenna, a first proximity sensor, a second antenna, a second proximity sensor, a detection module, a control module and a processor. The detection module that detects a first approach signal from the first proximity sensor and a second approach signal from the second proximity sensor. The control module that initiates the second antenna to receive signals if the strength of the first approach signal is stronger then the strength of the second approach signal or initiates the first antenna to receive signals if the strength of the second approach signal is stronger then the strength of the first approach signal. The processor that controls the detection module, the comparison module and the control module.

### BACKGROUND

1. Technical Field

The present disclosure relates to an electronic device with multiple antennas, and more particularly to an electronic device with multiple antennas optimizing antenna efficiency through proximity sensors.

2. Description of Related Art

Portable devices often include multiple antennas to receive all kind of signals from different frequency channels. However, antennas receivers may generate massive electromagnetic waves to affect performance of the multiple antennas. Therefore, there is room for improvement within the art.

### BRIEF DESCRIPTION OF THE DRAWINGS

FIG. 1 is the block diagram of an exemplary embodiment of an electronic device with multiple antennas of the present disclosure.

FIG. 2 is a flowchart of an exemplary embodiment of an antenna operation method of the present disclosure.

### DETAILED DESCRIPTION

The present disclosure is cross reference to the attorney docket number US31307. In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

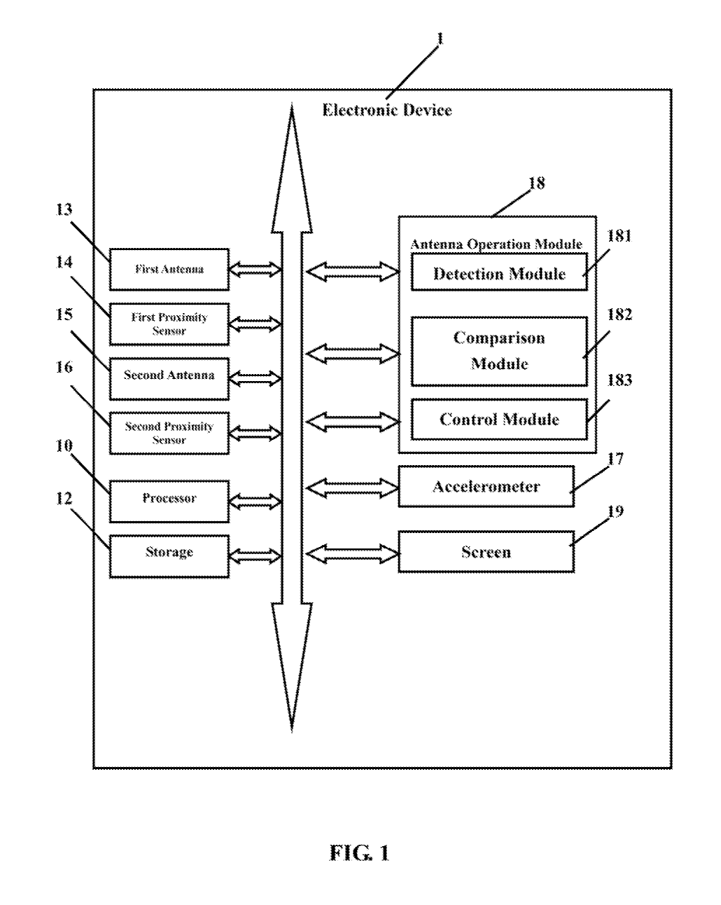

FIG. 1 is the block diagram of an exemplary embodiment of an electronic device with multiple antennas of the present disclosure. The electronic device 1 includes a processor 10, a storage 12, a first antenna 13, a first proximity sensor 14, a second antenna 15, a second proximity sensor 16, an accelerometer 17, a antenna operation module 18 and a screen 19. In an exemplary embodiment, the antenna operation module 18 is stored in the storage 12. The processor 10 controls the first antenna 13, the first proximity sensor 14, the second antenna 15, the second proximity sensor 16, the accelerometer 17 and the multiple antenna operation modules 18 to execute the functions described below. In an exemplary embodiment, the electronic device 1 is a cell phone, e-book reader or a personal digital assistor (PDA).

The electronic device 1 is generally controlled and coordinated by an operating system, such as UNIX, Linux, Windows, Mac OS, an embedded operating system, or any other compatible system. Alternatively, the broadcast server 1 may be controlled by a proprietary operating system. Typical operating systems control and schedule computer processes for execution, perform memory management, provide file system, networking, and I/O services, and provide a user interface, such as a graphical user interface (GUI), among other tasks.

In an exemplary embodiment, the proximity sensor is an optical sensor, magnetic sensor and a capacitance sensor. The accelerometer 18 detects a position state of the electronic device 1. The proximity sensors detects whether an object, such as a user, is approaching. The proximity sensors send a feedback signal to the processor 10. The strength of the feedback signal presents how close a user is to the electronic device 1. The screen 19 graphically displays information to user through the graphic user interface.

The electronic device 1 can stand at a standing state, a side state, a horizontal state and a vertical state. A width side up state is defined as the standing state. A length side up state is defined as the side state. The horizontal state is defined as a state that the length side is horizontal to the ground level. The vertical state is defined as a state that the width side is horizontal to the ground level.

The first proximity sensor 14 and the second proximity sensor 16 are located at different portions of the electronic device 1. The first antenna 13 and the first proximity sensor 14 are both located at a first portion of the electronic device 1. The second antenna 15 and the second proximity sensor 16 are both located at a second portion. In an exemplary embodiment, the first portion is the top portion of the electronic device 1, and the second portion is the right side portion of the electronic device 1. The top portion and the right portion correspondingly construct a contact substantially 90 degree angle contact portion with each other. It should be noticed that the electronic device 1 can have more than two antennas and proximity sensors.

The multiple antennas operation system includes a detection module 181, a comparison module 182 and a control module 183. The detection module 181 detects a first approach signal from the first proximity sensor 14 and a second approach signal form the second proximity sensor 16. The comparison module 182 compares the strength of the first approach signal with the strength of the second approach signal to decide which approach signal is stronger. The control module 183 initiates the second antenna 15 to receive signals when the strength of the first approach signal is stronger than the second approach signal. The control module 183 initiates the first antenna 13 to receive signals when the strength of the second approach signal is stronger than the first approach signal.

In addition, the control module 164 predefines the first antenna 13 and the second antenna 15 as a silent antenna. When the strength of the first approach signal and the strength of the second approach signal are determined the same through the comparison module 182, the control module 164 initiates the silent antenna to receive signals. Moreover, the control module 164 initiates the silent antenna when the first proximity sensor 14 and the second proximity sensor 16 both receive no approach signal. When the electronic device 1 is at the vertical state or the width side up state, the control module initiates the first antenna 13 to receive signals. When the electronic device 1 is at the horizontal state or the length side up state, the control module initiates the second antenna 15 to receive signals.

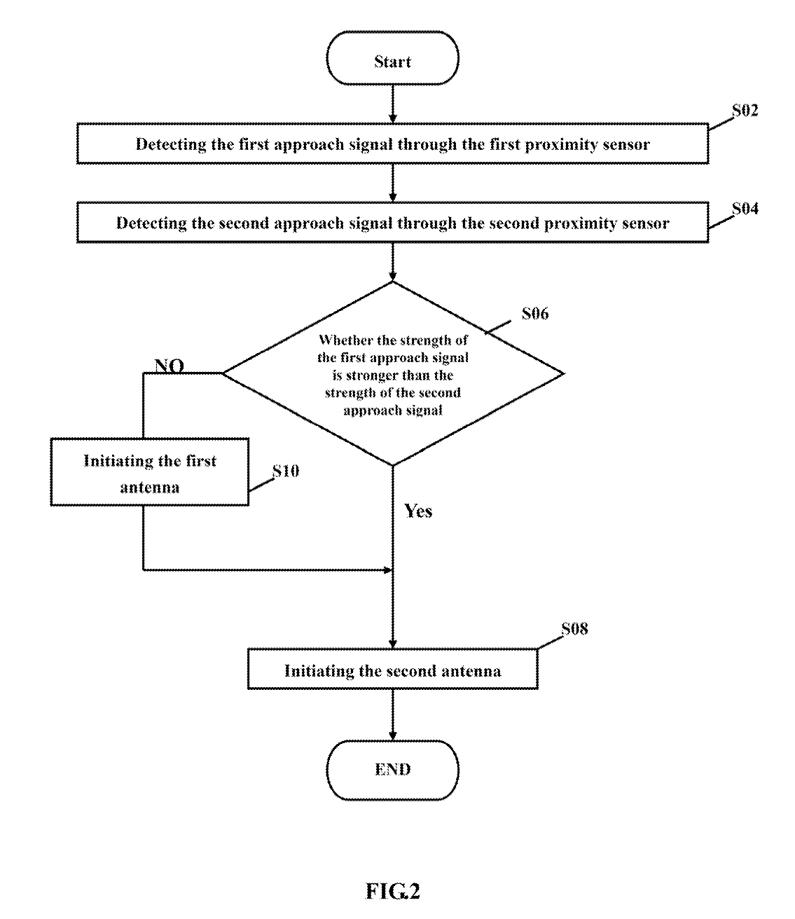

FIG. 2 is a flowchart of an exemplary embodiment of an antenna operation method of the present disclosure. In the block S02, the detection module 181 detects the first approach signal through the first proximity sensor 14.

In the block S04, the detection module 181 detects the second approach signal through the second proximity sensor 16.

In the block S06, the comparison module 182 compares the strength of the first approach signal with the strength of the second approach signal to determine whether the strength of the first approach signal is stronger than the second approach signal.

In the block S08, the control module 183 initiates the second antenna 15 to receive signals when the strength of the first approach signal is stronger than the strength of the second approach signal.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device with multiple antennas, comprising:
a first antenna;
a first proximity sensor that is located with the first antenna at a first side portion of the electronic device;
a second antenna;
a second proximity sensor that is located with the second antenna at a second side portion of the electronic device;
a detection module that detects a first approach signal from the first proximity sensor and a second approach signal from the second proximity sensor;
a comparison module that compares the strength of the first approach signal with the strength of the second approach signal;
a control module that initiates the second antenna to receive signals if the strength of the first approach signal is stronger then the strength of the second approach signal or initiates the first antenna to receive signals if the strength of the second approach signal is stronger then the strength of the first approach signal; and
a processor that controls the detection module, the comparison module and the control module.

2. The electronic device of claim 1, wherein the control module defines a silent antenna from one of the first antenna and the second antenna and initiates the silent antenna when the strength of the first approach signal and the strength of the second approach signal are equal.

3. The electronic device of claim 1, wherein the control module initiates the silent antenna when the detection module receives no signals from the first proximity sensor and the second proximity sensor.

4. The electronic device of claim 1, further comprising:
an accelerometer for detecting the position of the electronic device.

5. The electronic device of claim 4, wherein the positions of the electronic device is selected from the group of a standing state, a side state, a horizontal state and a vertical state.

6. The electronic device of claim 5, wherein the control module initiates the first antenna when the detection module detects no signals and the electronic device is at the vertical state.

7. The electronic device of claim 5, wherein the control module initiates the second antenna when the detection module detects no signals and the electronic device is at the horizontal state.

8. An antenna operation method of an electronic device with multiple antennas, comprising:
detecting a first approach signal from a first proximity sensor and a second approach signal from a second proximity sensor;
comparing the strength of the first approach signal with the strength of the second approach signal; and
initiating a first antenna when the strength of the second approach signal is stronger than the strength of the first approach signal.

9. The antenna operation method of claim 8, further comprising:
initiating a second antenna when the strength of the first approach signal is stronger than the strength of the second approach signal.

10. The antenna operation method of claim 8, further comprising:
predefining a silent antenna from one of the first antenna and the second antenna; and
initiating the silent antenna when the first approach signal and the second approach signal are equal.

11. The antenna operation method of claim 10, further comprising:
initiating the silent antenna when the first proximity sensor and the second proximity sensor both receive no signal.

12. The antenna operation method of claim 8, further comprising:
detecting the position states selected from the group of a standing state, a side state, a horizontal state and a vertical state.

13. The antenna operation method of claim 12, further comprising:
initiates the first antenna when the electronic device is at the standing state.

14. The antenna operation method of claim 12, further comprising:
initiates the second antenna when the electronic device is at the side state.
